(19) United States
(12) Patent Application Publication
(10) Pub. No.: US 2015/0007004 A1
(43) Pub. Date: Jan. 1, 2015

(54) METHODS AND SYSTEMS FOR MAKING CUSTOM PHOTO BOOKS

(71) Applicant: The Procter & Gamble Company, Cincinnati, OH (US)

(72) Inventor: Rachael Elizabeth KENDRICK, Amsterdam (NL)

(21) Appl. No.: 14/315,688

(22) Filed: Jun. 26, 2014

Related U.S. Application Data
(60) Provisional application No. 61/840,512, filed on Jun. 28, 2013.

(51) Int. Cl. G06F 17/24

(52) U.S. Cl. CPC G06F 17/248
USPC 715/202

(57) ABSTRACT

Methods and systems for transforming a photo book template into a customized photo book wherein at least one photo and the comments associated therewith are uploaded from a user's social networking account.

### FIELD OF THE INVENTION

The disclosure generally relates to facilitating the customizing of digital photo books using a variety of inputs including images and text from social media applications.

### BACKGROUND OF THE INVENTION

The desire to memorialize and share joyous events, especially milestone events like the birth and early years of a child, is timeless. What quickly becomes dated is the technology employed to do. While scrapbooking of hard copy photos, cards, newspaper articles, and mementos, possibly with narratives or comments, continues to be useful, it suffers from many drawbacks. Scrapbooks may take up a lot of space, which is difficult for those who do not have adequate storage space available to them. They may also be difficult when formatting, e.g. photos, newspaper clippings, etc., may not easily fit within the page size of the scrapbook and it may not be easy to re-size such items. Usually, items inserted into the scrapbook must be fixed there using adhesive or other fastening means. Further, scrapbooks are difficult to share amongst family and friends since either multiple copies must be made and distributed or family and friends must come to a venue where the user can physically show the scrapbook.

It is known to create photo books using online services offered by, e.g. Shutterfly and Snapfish. This concept allows a user to upload photos and enter them into an online template of a photo book, add narratives if desired, and then have the photo book printed in a hard copy and shipped to the user or another. This concept addresses some of the issues presented by scrapbooking, but still limits the sharing of the final product.

Social media sites, e.g. Facebook, have recently become generally popular and among other features, allow users to share photos, including photos arranged in online albums with others, and permit the user to determine who among family, friends, or others, may view the album. Permitted others may comment on the album itself or the photos it contains, and the user and possibly others may view the comments posted, and may respond to them. This concept address some of the issues presented by scrapbooking, but does not provide a means for making a hard copy version of the album or for making a photo book that includes more narrative or textual information other than comments posted via the social networking site.

It is desirable to provide methods and systems for making custom photo albums digitally, which may be shared with others digitally and optionally printed in hard copy.

It is also desirable to provide methods and systems for making custom photo albums where photos may be uploaded from an existing inventory of photos on a social networking website in a user's account and optionally from another source, e.g. a hard drive or flash drive or other storage media.

It is also desirable to provide methods and systems for making custom photo albums where comments from others posted to a user's social media site, e.g. timeline, photos, albums, etc., are imported into the custom photo album.

It is also desirable to provide methods and systems for making custom photo albums where additional comments and narratives may be added to the custom photo album by a user.

It is also desirable to provide methods and systems for making custom photo albums where then current events information may be added to the custom photo album by a user.

It is believed that the present invention addresses one or more of these desires.

### SUMMARY OF THE INVENTION

Methods and systems for transforming a photo book template into a customized photo book wherein at least one photo and the comments associated therewith are uploaded from a user's social networking account,

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings are necessarily to scale.

FIGS. 1 to 11 depict example screen shots which the system may present to a user when transforming the baby book template into a customized photo album, in various embodiments of the invention.

### DETAILED DESCRIPTION OF THE INVENTION

Methods and systems are disclosed herein, the system comprising, in an embodiment, a server configured to receive data, from and/or about a user or their social media networking account, into a database, wherein the data may be associated with a computer or smart device, which in turn, may be associated with the database. A computer-readable medium having a memory and executable instructions stored thereon is disclosed herein. Where it is described that the system “allows” a user to perform some task, it is intended that the system is capable of executing the instruction to complete the task with or without further user input, and includes the necessary or useful hardware, software, operating systems, or other computer, media, and/or electronic means to do so.

In an embodiment, users utilize a toolbar operating in a browsing application (e.g. Internet Explorer) to efficiently interact with the system. In some embodiments, users access the system via a standard web interface. In another embodiment, a social networking system supports an application programming interface (API) to directly access the system. In some embodiments, the API is also supported on a standard platform of a smartphone (e.g., Symbian OS). In other embodiments, an application is provided to interact with the system using a manufacturer-specific platform (e.g., the iPhone platform provided by Apple, Inc).

As used herein, the term “smart device” refers to any portable device capable of running one or more software applications. Smart devices also can be connected to the Internet or one or more computer networks. Smart devices include, but are not limited to, smartphones (e.g., iPhone, Galaxy, Droid, and Blackberry), personal digital assistants (aka pda's), netbooks, notebooks, GPS devices, tablets, e-readers, iPads, and mobile game consoles (e.g., Nintendo DS, Sony PSP).

The system includes one or several servers, each of which includes a computer-readable memory on which software instructions are stored, and a processor to execute these instructions. The servers include a network interface to connect to a wide area network (WAN). In some embodiments, the system includes a database to store user data, participant data, item identifiers and other data related to items included in photo albums, etc. Some or all communications between the system and hosts operated by users are encoded in some embodiments of the system. In an embodiment, the encoding is provided by the secure socket layer (SSL) and the appropriate digital certificates stored at the system and/or hosts operated by users.

In an embodiment the system includes a web gateway through which users access applications run on the application server. For ease of illustration, each of the web gateway, the application server, and the electronic store server may be considered as a single host. It is noted, however, that the each of the devices can include one or several physical computer hosts, each including a processor to execute computer instructions stored on a computer-readable medium. The system further includes a user database to store user information for each user who has set up an account with the system. In some embodiments, the database is implemented on a computer host in which a processor is coupled to a persistent memory. In an embodiment, the database is a relational database that includes multiple tables interconnected via logical links, with one table including data records for respective baby care products, another table including data records for respective users, etc.

Also included are embodiments of a non-transitory computer-readable medium. Some embodiments of the non-transitory computer-readable medium include one or more programs that cause a computing device to execute some or all of the steps contemplated by the methods and/or systems described herein. It is contemplated that the computing device(s) utilized with such medium are capable of using logic to execute the steps with or without additional input from the user, as appropriate, and will comprise one or more components necessary or useful to executing such steps, e.g. providing multiple user interfaces to allow input/access to the user from various devices operated by the user. Non-limiting examples of such components include a user-interface, a processor, input/output hardware, network interface hardware, a data storage component, and a memory component. Further, the logic may include software, hardware, and/or firmware for executing the steps.

Herein, the system is described as being useful to create a “baby book” by the methods also described herein. However, it is intended that the methods and systems described herein may also be applied to create albums for other time periods of one's lifetime, e.g. birth to death, pre-teen years, teen years, etc., or events, e.g. graduation, marriage, job promotion, retirement, military service, election to public office, sports seasons and achievements, etc., collectively referred to as “photo books”.

Herein, the system is described as being useful to upload photos into a baby book by the methods also described herein. However, it is intended that the methods and systems described herein may also be useful to uploading videos and/or audio dips, e.g. a voice over narrative, particularly in those embodiments where the baby book is published electronically.

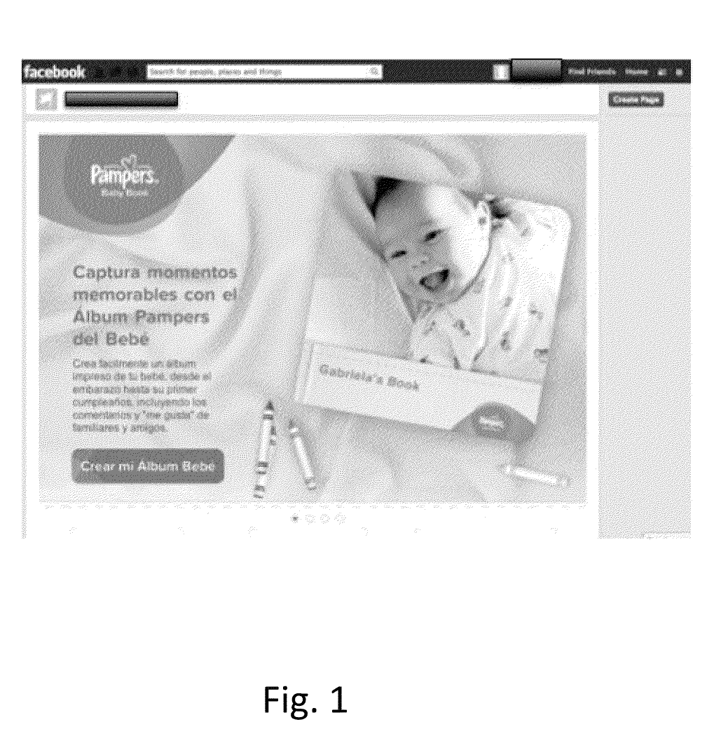

In an embodiment, a user may interact with the system. For example, a user may be presented with a preview screen, an example of which is shown in FIG. 1. For example, this screen may be generated in response to a user accessing the server by running an “app” or by going to a website including being logged in to the user's social networking account. A typical navigation bar may be present, and there may also be included an image of a baby book, a description of a baby book, and a link that when clicked on will take the user to a screen that allows them to create a new baby book. The image of the baby book may be a link that when clicked on causes an example baby book to appear on screen, and a completed version using exemplary photos, comments, etc. may be shown. As shown in FIG. 1, the language used may be any language understandable to the user. A user may be provided with a prompt to select a language of their choice. In another embodiment, a user may be provided with link or button which may be activated by the user to select another language than default language that the screen began in.

If the user clicks the link to create their own baby book, this may cause the user to be provided with a series of interactive screens that allows the user to select a template for a baby book, populate the book with photo images, other images, social media comments, additional comments inputted by the user, and additional information provided by the system, as described herein.

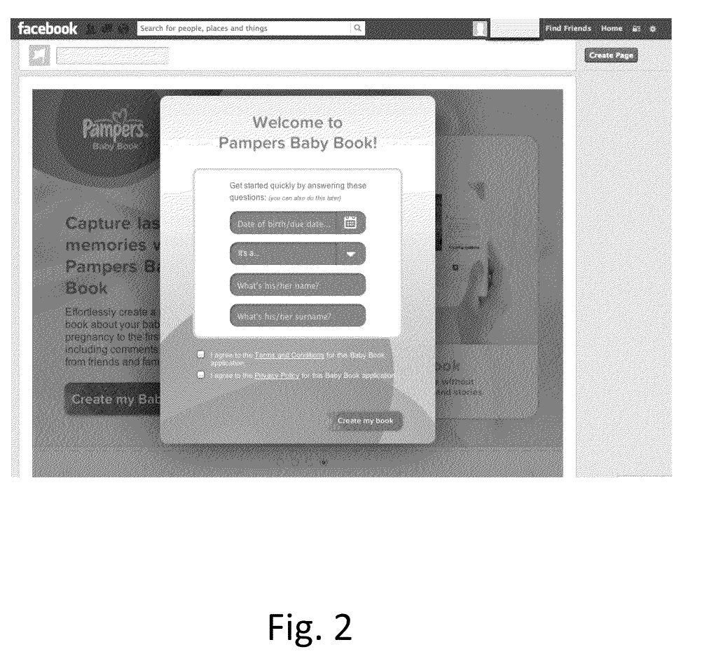

As shown in FIG. 2, a user may be prompted to indicate whether they are already registered with the system, would like to register, or would like to use their registration within another system, e.g. a social networking site account as their registration with the present system. The system may accept the entry of a registered username and corresponding password, or allow the user to create a new account, or accept the registration information of the user from the user's social networking system. Once the user is accepted as registered, the user may interact further with the system. It is contemplated that the registration step may precede or follow the step of allowing a user to view a sample baby book and/or indicate their desire to create a custom baby book for themselves. It is also contemplated that a user may begin customizing a new baby book or may return to the system to continue customizing a baby book that the user had already begun customizing and had saved as a draft. It is also contemplated that the user's registration may be utilized by another for direct marketing purposes. For example, a registered user may be contacted by a marketer and offered coupons against the purchase of the baby book or other items sold. The other items may be ones bearing some or all of the photos and additional information contained in the baby book or they may be items that a seller deems related or ancillary to the baby book, e.g. diapers, baby wipes, toys, children's learning tools, books, subscriptions to parenting magazines, and donations (including matching funds or not) to charitable organizations. Yet other items may be ones not apparently related at all, e.g. discounts at home improvement stores and restaurants.

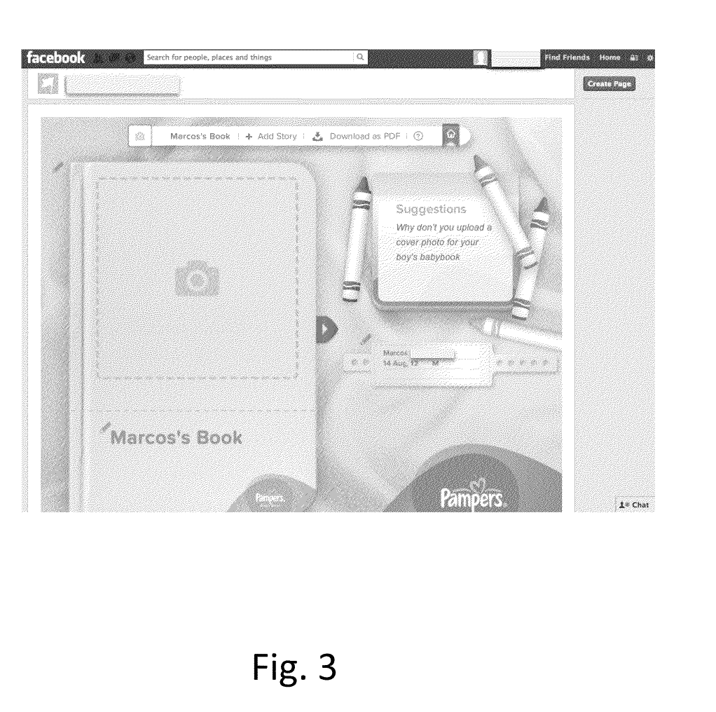

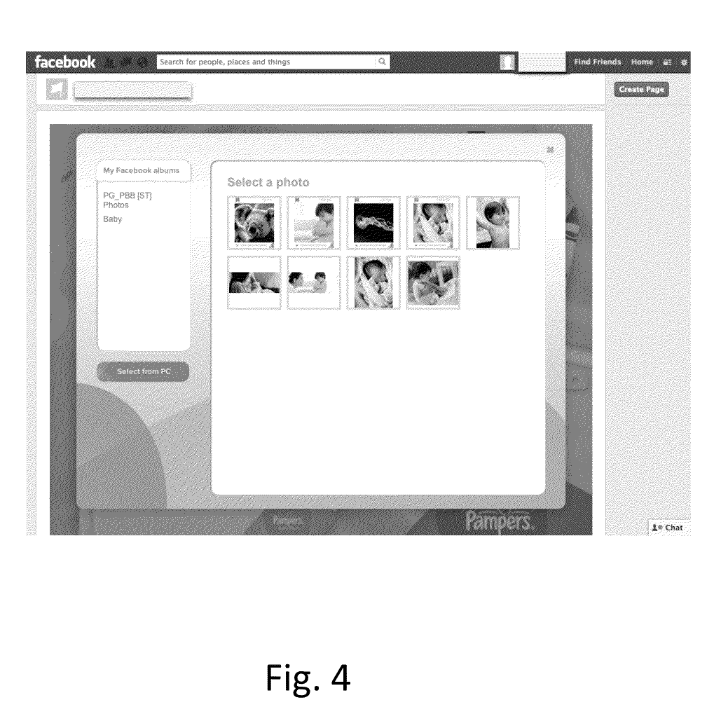

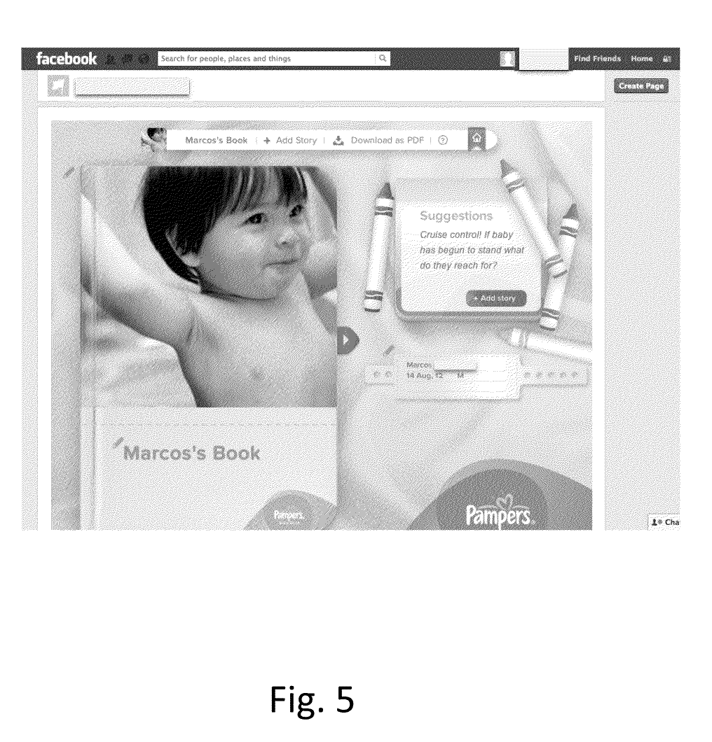

As shown in FIG. 3, a user may be provided with a template of a baby book, starting with the cover, and be prompted to customize it. For example, a suggestion may be provided on the screen asking the user to upload a photo to be used on the cover of the baby book. The user may click on the image of the empty cover and then, as shown in FIG. 4, be prompted to select a photo for uploading from their social media account, whether from various photos or an existing photo album, or from another source, e.g. their computer's hard drive, a flash drive, their smart device's storage space, etc. Once the user identifies the photo image they want to upload, the user may indicate so to the system and the photo may be uploaded and placed into a position on the cover of the baby book, as is shown in FIG. 5. The user may be prompted by the system to add a title, and other information, such as the child's name and date of birth. The user may also be prompted to add narrative words of their choosing or to select from prepared narratives or quotes including inspirational messages relating to a child's birth, the journey they begin at birth, or other joyful, religious, or happy sentiments.

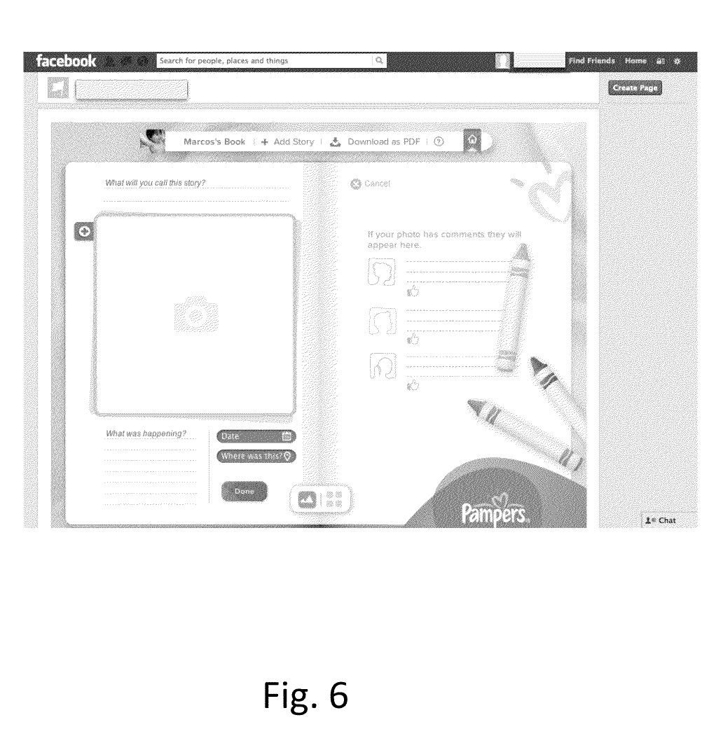

Referring to FIGS. 5 and 6, the user may be prompted by the system to add photo images of the child or of others including family members and friends to the ensuing pages of the baby book. These photo images may be uploaded from the user's social networking site or elsewhere, as described above. For each photo image, the user may be prompted to add narrative words describing what is occurring in the photo, or to choose words of their own accord, or where the uploaded photo is one from the user's social networking account, to add comments posted by the user or others that are associated with the photo on the social networking site. For example, the user posts a photo of their newborn child (who is the subject of the baby book) along with an older sibling on the social networking site and describes it as “Here is a picture of Rori holding her baby sister Sophie for the first time!” and friends or family of the user post comments on the social networking site saying

“How cute!” and “You're gonna have your hands full when they get older!”, such comments being associated through the social networking site with the originally posted picture. The user may import their own comment and/or the comments from the friends and family into the baby book page. It is contemplated that the user may edit individual comments and select which comments they wish to import into the baby book. Selectivity may be based on appropriateness of the comment, redundancy in view of other comments, length of the comment, general formatting, or any other criteria whether objective or subjective applied by the user. The user may also be prompted to provide the date and/or location that the photo was taken, and to name the individuals in the photo. Advantageously, the user may either edit the size and shape of the photo prior to adding it to the baby book, or the system may prompt the user to format the photo to fit the page or preferred dimensions of the user, or may automatically edit the photo's format to fit the page.

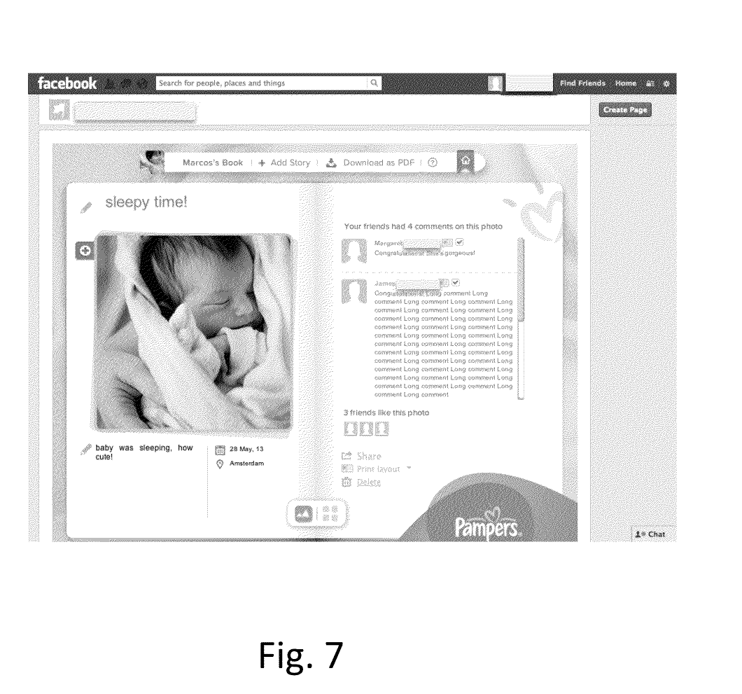

Throughout the process of the user utilizing the system to customize new pages in the baby book, the system may provide displays of the pages in progress, as is shown in FIG. 7, or may provide a display of all pages once the photos and other data are input. The user may be allowed to view each or all pages at their discretion. The user may be prompted to indicate whether they approve of the content and format of the baby book page or if they wish to edit. The user may click a button indicating they would like to edit and the system may provide guidance and tools for changing text, comments, or the position of the photo or removing it entirely and either loading a different photo, reloading the original photo, or reloading the original photo after it has been edited inside or outside of the system.

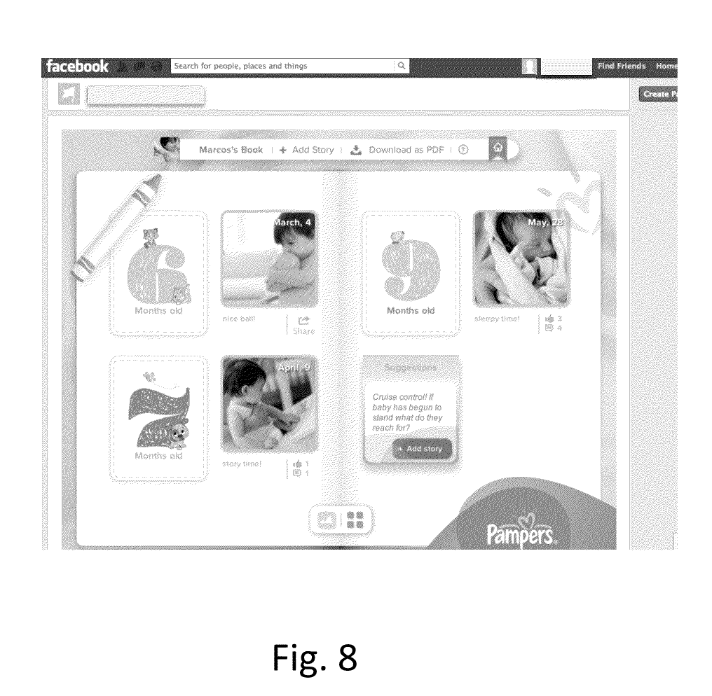

To aide with editing, or at least determining whether a need to edit exists, the system may allow the user to view all or some subset of the baby book pages in an overview format, as shown in FIG. 8, where several pages are displayed on a single screen and the user can utilize this to assess the flow of the overall story and see how each page fits in the context of others.

The number of pages in the baby book may be pre-determined and the system will be prepared to only offer that set number of pages, or the number of pages may be determined by the user either independently or by selecting from options programmed into the system. The number options may be scheduled with corresponding prices, e.g. the more pages, the higher the cost, or there may be no cost to the user at all.

The user may be prompted by the system to select a theme background for the whole baby book and/or graphics including borders and decorations and colors for each individual page. For example, a page on which a photo of the child is crawling may be decorated with pictures of vehicles of transportation, e.g. cars, trucks, trains, airplanes, denoting movement and transport. In another example, a page on which a photo of the child is eating may be decorated with pictures of food, restaurants, chef's hats, etc.

Regardless of the source of the uploaded photo, the user may also be prompted by the system to provide narrative words of their choosing or to select from prepared narratives or quotes including inspirational messages relating to a child's birth, the journey they begin at birth, or other joyful, religious, or happy sentiments, or simply what is depicted in the photo. The narrative words may also include chronologic information about the child, e.g. “Sophie at 2 mos.”, “Sophie's 1st Christmas”, etc.

The user may also be prompted to the user may also be prompted by the system to provide current events information of their choosing or to select from prepared information about current events. For example, a page of the baby book could include information on who was president of the United States when the baby was born, what significant technological advances occurred that year, who the popular bands/singers/actors/authors were, what the population of the US or the world was, what the price of a certain commodity or product was that year, what team won championships that year, what city the child was born in, etc. Generally, such information may be referred to in some instances as that which would be contained in a “time capsule”.

The user may indicate that they have completed editing or that there are no edits to make at all. The system may prompt the user to decide and indicate how they wish to publish the baby book; options may include publishing online via the user's social networking account, printing a hard copy of the baby book, or both.

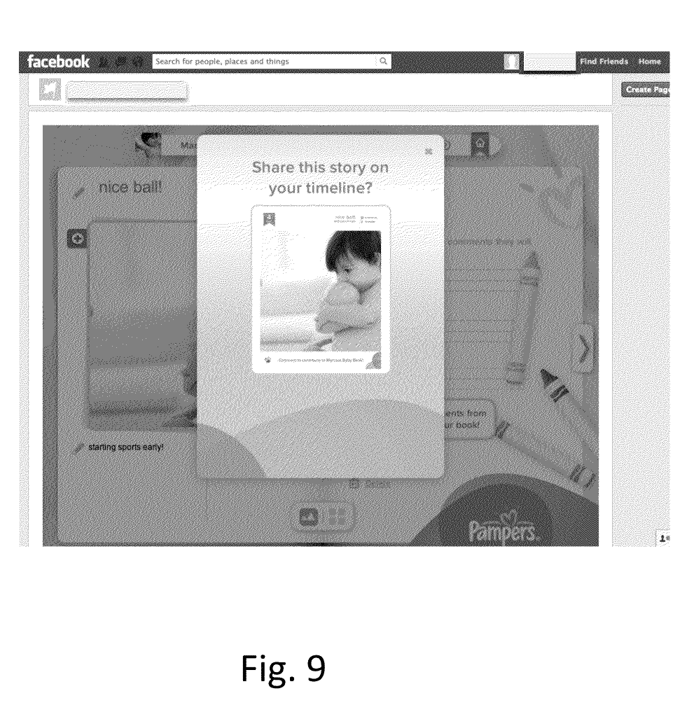

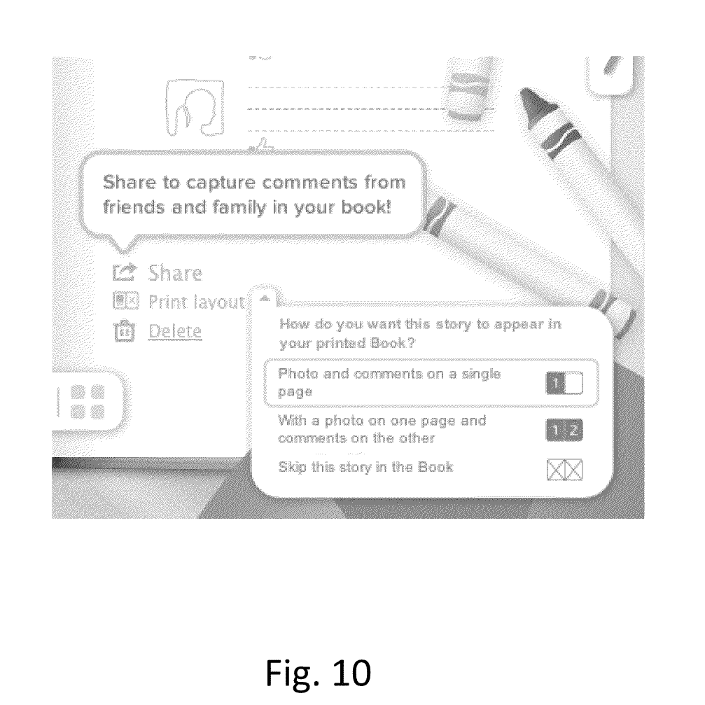

As shown in FIGS. 9 and 10, the user may choose to publish by “sharing” the baby book online via their social networking account. In response to the user indicating so, the system may allow the user to post the baby book to the user's social networking account, e.g. to their “timeline” or other suitable place of residence on the social networking site. This may attract others to make comments on the baby book generally or certain pages therein or any other subset thereof, In an embodiment, the user can collect those comments and return to the system to edit the baby book to include the new comments. In an embodiment, it is contemplated that the posting of a new baby book or new content to an existing baby book on the user's social networking account may trigger a message to be sent automatically to any locus of others having social networking accounts. For example, the user's friends and family may be automatically notified of the presence of new material, or only those who have commented or indicated a preference (also known as “like” or “thumbs up”) may be notified. Such notification may be executed via the social networking site itself or using a separate system, e.g. sending a tweet on Twitter or another electronic notification system.

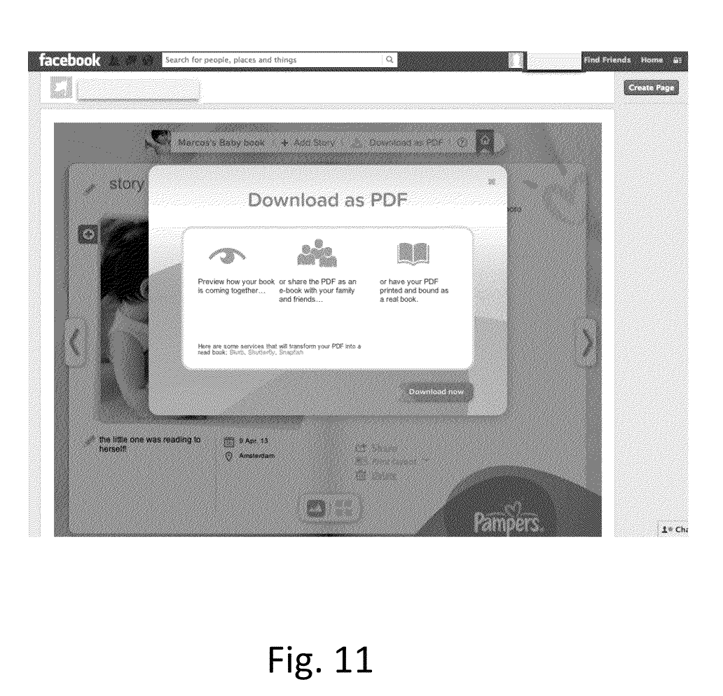

As shown in FIGS. 10 and 11, the user may choose to publish by printing the baby book into a pdf file or a hard copy, or both. The system may prompt the user to select certain format features, e.g. having the photo and comments on a single page vs. having the photo and comments on adjoining opposite pages, i.e. a spread. Further, the user may be prompted to select whether a given page is included in the baby book or not. In an embodiment, the system may allow the user to link directly to a provider who accepts the baby book file as is, and allows the user to then order a hard copy baby book to be printed including the content of the baby book file made using the present system. Alternatively, the system may allow the user to save the baby book file as a pdf (portable document format) file. The user may then either print the pdf file of the baby book by any printing means, or may connect with a provider who accepts pdf files, and allows the user to then order a hard copy baby book to be printed including the content of the baby book pdf file made using the present system. By exercising one or more of these choices, the user has a copy of a baby book that they can then share with family, friends, and/or others. It is also contemplated that the pdf file may be the source of content for printing on other items, e.g. coffee mugs, drink cups, tote bags, mouse pads, pillow cases, calendars, towels, and t-shirts.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method, in a computer-based online system having a memory, for transforming a photo book template into a customized photo book, comprising the steps of:
(a) electronically receiving a first message including a request to begin customizing a photo book template from a user;
(b) causing a template to be viewable by the user;
(c) electronically receiving one or more digital photos from the user, the photos being associated with the user's social networking account;
(d) electronically receiving comments associated with the photos from the social media networking account;
inserting and displaying the photos and comments on at least one page in the template thereby creating a customized photo book; and
storing the customized photo book in a storage media.

2. The method according to claim 1, wherein one or more additional photos are electronically received from the user, the additional photos not being associated with the user's social networking account.

3. The method according to claim 1, wherein the user is provided with one or more opportunities to add and edit photos, audio clips, video clips, comments, narratives, current events information, graphics, and the formatting of the photo book, thereby further transforming the photo book.

4. The method according to claim 1, wherein the user is provided with one or more opportunities to publish the photo book electronically, in hard copy, or both.

5. The method according to claim 4, wherein the user is provided with one or more opportunities to edit the photo book after publication.

6. The method according to claim 1, wherein the user is provided with one or more opportunities to obtain at least one of products, services, or discounts, which are related or unrelated to the content of the photo book.

7. The method according to claim 1, wherein the photo book is a baby book.

8. A system, in a computer-based online system having a memory, for executing a method of transforming a photo book template into a customized photo book, comprising the steps of:
(a) electronically receiving a first message including a request to begin customizing a photo book template from a user;
(b) causing a template to be viewable by the user;
(c) electronically receiving one or more digital photos from the user, the photos being associated with the user's social networking account;
(d) electronically receiving the comments associated with the photos from the social media networking account;
(e) inserting and displaying the photos and comments on at least one page in the template thereby creating a customized photo book; and
(f) storing the customized photo book in a storage media.

9. The system according to claim 8, wherein one or more additional photos are electronically received from the user, the additional photos not being associated with the user's social networking account.

10. The system according to claim 8, wherein the user is provided with one or more opportunities to add and edit photos, audio clips, video clips, comments, narratives, current events information, graphics, and the formatting of the photo book, thereby further transforming the photo book.

11. The system according to claim 8, wherein the user is provided with one or more opportunities to publish the photo book electronically, in hard copy, or both.

12. The system according to claim 11, wherein the user is provided with one or more opportunities to edit the photo book after publication.

13. The system according to claim 8, wherein the user is provided with one or more opportunities to obtain at least one of products, services, or discounts, which are related or unrelated to the content of the photo book.

14. The system according to claim 8, wherein the photo book is a baby book.

15. A non-transitory computer-readable medium that stores a program that when executed by a computing device causes the computing device to perform at least the steps comprised in the method according to claim 1.

16. A non-transitory computer-readable medium that stores a program that when executed by a computing device causes the computing device to perform at least the steps comprised in the system according to claim 8.
